(19) United States
(12) Patent Application Publication
(10) Pub. No.: US 2025/0078231 A1
(43) Pub. Date: Mar. 6, 2025

(54) METHOD AND APPARATUS FOR COLLECTING DATA THROUGH HMI SCREEN RECOGNITION AND IMAGE ANALYSIS BY USING CAMERA

(71) Applicant: IOE SOFT CO., LTD., Seongnam-si (KR)

(72) Inventor: Ho Joon LEE, Seoul (KR)

(73) Assignee: IOE SOFT CO., LTD., Seongnam-si (KR)

(21) Appl. No.: 18/534,762

(22) Filed: Dec. 11, 2023

Related U.S. Application Data
(63) Continuation of application No. PCT/KR2023/019277, filed on Nov. 27, 2023.

(30) Foreign Application Priority Data
Aug. 29, 2023 (KR) 10-2023-0113915

(51) Int. Cl. G06T 7/00

(52) U.S. Cl. CPC G06T 7/00; G06T 2207/20081

(57) ABSTRACT

Disclosed is a method for collecting data through HMI screen recognition and image analysis by using a camera. According to one embodiment of the present invention, the method for collecting the data through the HMI screen recognition and the image analysis by using the camera includes: receiving a first image obtained by capturing a screen of a human-machine interface (HMI) from an image camera; generating an image analysis result by analyzing the first image based on an artificial intelligence learning model configured to generate an analysis result by analyzing an image; and storing collection data corresponding to the first image based on the image analysis result.

### CROSS-REFERENCE TO RELATED APPLICATION

This application is a Continuation Application of PCT International Patent Application No. PCT/KR2023/019277 filed on Nov. 27, 2023, which claims priority to Korean Patent Application No. 10-2023-0113915 filed Aug. 29, 2023, respectively, which are all hereby incorporated by reference in their entirety.

### TECHNICAL FIELD

The present invention relates to a method and an apparatus for collecting data through HMI screen recognition and image analysis by using a camera.

### BACKGROUND ART

The contents that will be described below simply provide background information related to one embodiment of the present invention without constituting the related art.

In a case of a factory or a power plant, when a supervisory control and data acquisition (SCADA) system communicates with a programmable logic controller (PLC) and an input/output sensor to obtain information on a device operation, the information may be displayed on a human-machine interface (HMI). The HMI may show the information in a graph, a chart, or other visual forms that are easy to read and understand.

However, S/W installation and system modification for data collection of the SCADA system or the PLC may be very limited, so that it may be very difficult to collect data for an integrated management system.

Therefore, instead of an existing scheme of modifying data directly from the system, a method for collecting data by recognizing and analyzing a chart and a number from an HMI screen by using image recognition may be required.

### DISCLOSURE

### Technical Problem

An object of the present invention is to collect data through HMI screen recognition and image analysis by using a camera.

In addition, an object of the present invention is to train an artificial intelligence learning model by using the collected data.

### Technical Solution

To achieve the objects described above, according to one embodiment of the present invention, there is provided a method for collecting data through HMI screen recognition and image analysis by using a camera, the method including: receiving a first image obtained by capturing a screen of a human-machine interface (HMI) from an image camera; generating an image analysis result by analyzing the first image based on an artificial intelligence learning model configured to generate an analysis result by analyzing an image; and storing collection data corresponding to the first image based on the image analysis result.

After the storing of the collection data, the method may further include training the artificial intelligence learning model by using the collection data, and the artificial intelligence learning model may include: a first artificial intelligence learning model configured to generate a determination result by determining information displayed on the HMI in the first image; and a second artificial intelligence learning model configured to generate the image analysis result for the first image based on the determination result and the information.

The training of the artificial intelligence learning model may include: providing a first interface, which is capable of receiving an input of first data modification information for the determination result from a user, to a user terminal; generating the image analysis result for the first image based on the first data modification information for the determination result received through the first interface; providing a second interface, which is capable of receiving an input of second data modification information for the image analysis result from the user, to the user terminal; performing retraining of the first artificial intelligence learning model and the second artificial intelligence learning model based on the first data modification information for the determination result received through the first interface and the second data modification information for the image analysis result received through the second interface; and updating the first artificial intelligence learning model and the second artificial intelligence learning model through the retraining.

After the providing of the second interface, the method may further include: displaying a reflection ratio for each item starting from items having a greatest influence on the image analysis result, and displaying modifiable items among the items; displaying, when a first item, which is one of the items, is selected by the user, samples of the image analysis result in which a reflection ratio for the first item is changed; and receiving a first image analysis result selected by the user among the samples, and the performing of the retraining may include performing retraining of the second artificial intelligence learning model based on the first image analysis result.

After the storing of the collection data, the method may further include providing the collection data to the user through an integrated dashboard.

In addition, according to one embodiment of the present invention, there is provided an apparatus for collecting data through HMI screen recognition and image analysis by using a camera the apparatus including: an image reception unit configured to receive an image from an image camera; an image analysis unit configured to generate an image analysis result by analyzing the image based on an artificial intelligence learning model; and a data storage unit configured to store collection data corresponding to the image.

The image reception unit may be configured to receive a first image obtained by capturing a screen of a human-machine interface (HMI) from the image camera, the image analysis unit may be configured to generate an image analysis result by analyzing the first image based on the artificial intelligence learning model configured to generate an analysis result by analyzing an image, and the data storage unit may be configured to store collection data corresponding to the first image based on the image analysis result.

The apparatus may further include an artificial intelligence training unit configured to train the artificial intelligence learning model, the artificial intelligence training unit may be configured to train the artificial intelligence learning model by using the collection data, and the artificial intelligence learning model may include: a first artificial intelligence learning model configured to generate a determination result by determining information displayed on the HMI in the first image; and a second artificial intelligence learning model configured to generate the image analysis result for the first image based on the determination result and the information.

The artificial intelligence training unit may be configured to: provide a first interface, which is capable of receiving an input of data modification information for the determination result from a user, to a user terminal; generate the image analysis result for the first image based on the data modification information for the determination result received through the first interface; provide a second interface, which is capable of receiving an input of data modification information for the image analysis result from the user, to the user terminal; perform retraining of the first artificial intelligence learning model and the second artificial intelligence learning model based on the data modification information for the determination result received through the first interface and the data modification information for the image analysis result received through the second interface; and update the first artificial intelligence learning model and the second artificial intelligence learning model through the retraining.

The artificial intelligence training unit may be configured to: display, through the second interface, a reflection ratio for each item starting from items having a greatest influence on the image analysis result, and display modifiable items among the items; display, when a first item, which is one of the items, is selected by the user, samples of the image analysis result in which a reflection ratio for the first item is changed; receive a first image analysis result selected by the user among the samples; and perform retraining of the second artificial intelligence learning model based on the first image analysis result.

### Advantageous Effects

According to the present invention, data can be collected through HMI screen recognition and image analysis by using a camera.

In addition, according to the present invention, an artificial intelligence learning model can be trained by using the collected data.

### DESCRIPTION OF DRAWINGS

FIG. 1 is a block diagram showing entities for collecting data through HMI screen recognition and image analysis by using a camera according to one embodiment of the present invention.

FIG. 2 is an operation flowchart showing a method for collecting data through HMI screen recognition and image analysis by using a camera according to one embodiment of the present invention.

FIG. 3 is an operation flowchart showing a method for collecting data through HMI screen recognition and image analysis by using a camera according to one embodiment of the present invention.

FIG. 4 is an operation flowchart showing a method for collecting data through HMI screen recognition and image analysis by using a camera according to one embodiment of the present invention.

FIG. 5 is an operation flowchart showing a method for collecting data through HMI screen recognition and image analysis by using a camera according to one embodiment of the present invention.

FIG. 6 is an operation flowchart showing a method for collecting data through HMI screen recognition and image analysis by using a camera according to one embodiment of the present invention.

FIG. 7 is a view showing a configuration of an apparatus for collecting data through HMI screen recognition and image analysis by using a camera according to one embodiment of the present invention.

FIG. 8 is a view showing a computer system according to one embodiment of the present invention.

### MODE FOR INVENTION

The present invention will be described in detail below with reference to the accompanying drawings. In this case, redundant descriptions and detailed descriptions of well-known functions and configurations that may unnecessarily obscure the gist of the present invention will be omitted. Embodiments of the present invention are provided to more completely describe the present invention to a person having ordinary skill in the art. Therefore, shapes, sizes, and the like of elements in the drawings may be exaggerated for a clearer description.

Throughout the present disclosure, when some part “includes” some elements, unless explicitly described to the contrary, it means that other elements may be further included but not excluded.

Hereinafter, exemplary embodiments of the present invention will be described in detail with reference to the accompanying drawings.

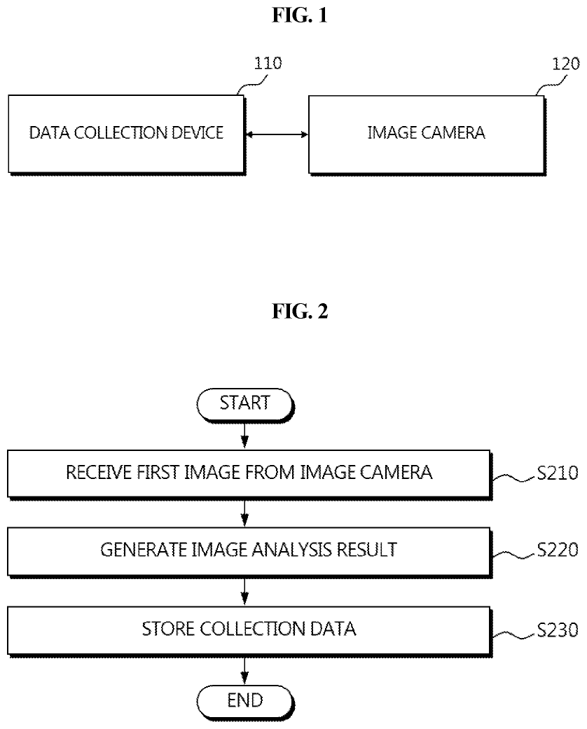

FIG. 1 is a block diagram showing entities for collecting data through HMI screen recognition and image analysis by using a camera according to one embodiment of the present invention.

Referring to FIG. 1, according to one embodiment of the present invention, entities for collecting data through HMI screen recognition and image analysis by using a camera may include a data collection device 110 and an image camera 120.

The data collection device 110 may refer to a device configured to receive an image from the image camera 120.

The data collection device 110 may be a device configured to generate an image analysis result by analyzing an image by using an artificial intelligence learning model.

The data collection device 110 may be a device configured to store collection data corresponding to the image.

The image camera 120 may be a device configured to provide the image to the data collection device 110.

The data collection device 110 and the image camera 120 may be interconnected through a communication network.

The communication network may refer to an access path for allowing data to be transmitted and received between the above entities. For example, the communication network may encompass wired networks such as local area networks (LANs), wide area networks (WANs), metropolitan area networks (MANs), and integrated service digital networks (ISDNs), or wireless networks such as wireless LANs, CDMA, Bluetooth, and satellite communications, but the scope of the communication network that is applicable to the present invention is not limited thereto.

FIG. 2 is an operation flowchart showing a method for collecting data through HMI screen recognition and image analysis by using a camera according to one embodiment of the present invention.

Referring to FIG. 2, according to a method for collecting data through HMI screen recognition and image analysis by using a camera of one embodiment of the present invention, first, a first image obtained by capturing a screen of a human-machine interface (HMI) may be received from an image camera (S210).

In this case, the first image may include an image obtained by capturing the screen of the HMI in real time.

Next, an image analysis result may be generated by analyzing the first image based on an artificial intelligence learning model configured to generate an analysis result by analyzing an image (S220).

Next, collection data corresponding to the first image may be stored based on the image analysis result (S230).

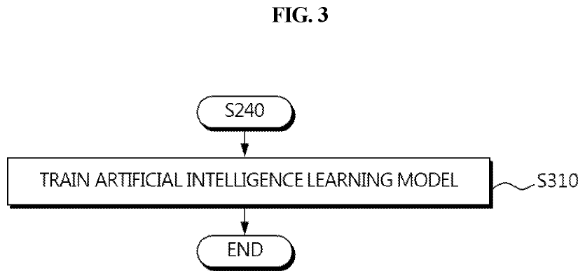

FIG. 3 is an operation flowchart showing a method for collecting data through HMI screen recognition and image analysis by using a camera according to one embodiment of the present invention.

Referring to FIG. 3, according to a method for collecting data through HMI screen recognition and image analysis by using a camera of one embodiment of the present invention, after the storing of the collection data, the artificial intelligence learning model may be trained by using the collection data (S310).

In this case, the artificial intelligence learning model may include: a first artificial intelligence learning model configured to generate a determination result by determining information displayed on the HMI in the first image; and a second artificial intelligence learning model configured to generate the image analysis result for the first image based on the determination result and the information.

In this case, the artificial intelligence learning model may be a model trained through supervised learning by using deep learning. The deep learning may refer to a technology in which a computer is trained by combining and analyzing external data by itself. This is a method that uses an artificial neural network mimicking a structure of neurons and synapses similar to a human brain to machine learning, and allows various neural networks to overlap each other so as to increase prediction accuracy.

In addition, the supervised learning may refer to a learning method that trains a model by using data having a predetermined answer and predicts a result for new data.

A general deep learning process may first initialize a parameter, and define a hyperparameter. In this case, the parameter may refer to a value that may be calculated through data as a variable determined within an artificial intelligence learning model, and the hyperparameter may refer to a value directly set by an algorithm user based on experience. The hyperparameter may vary according to a learning model or data without having a predetermined optimal value.

Next, training may be repeatedly performed a set number of times. When the learning process progresses, according to an order of the training, first, forward propagation may be performed through the artificial neural network. Next, a loss function may be calculated. In this case, the loss function may refer to a function for calculating a difference between an expected value according to an input and an actual value. Next, backward propagation may be performed through the artificial neural network. Next, the parameter may be updated. The trained model may be generated by repeatedly performing the above process a set number of times.

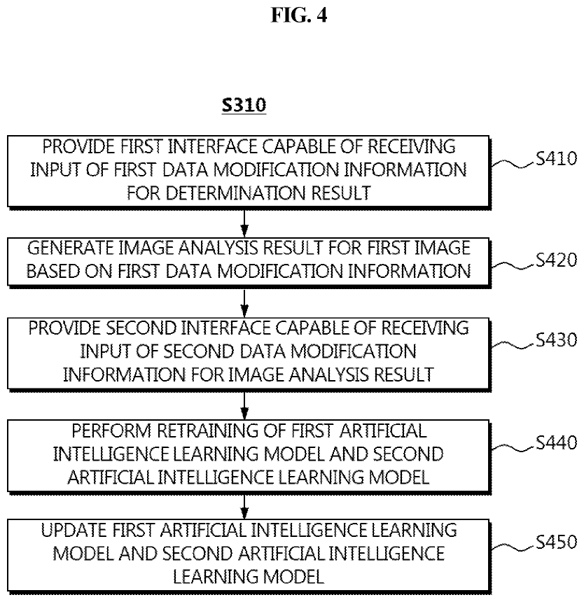

FIG. 4 is an operation flowchart showing a method for collecting data through HMI screen recognition and image analysis by using a camera according to one embodiment of the present invention.

Referring to FIG. 4, according to a method for collecting data through HMI screen recognition and image analysis by using a camera of one embodiment of the present invention, first, a first interface, which is capable of receiving an input of first data modification information for the determination result from a user, may be provided to a user terminal (S410).

The user may modify data through the first interface.

Next, the image analysis result for the first image may be generated based on the first data modification information for the determination result received through the first interface (S420).

Next, a second interface, which is capable of receiving an input of second data modification information for the image analysis result from the user, may be provided to the user terminal (S430).

Next, retraining of the first artificial intelligence learning model and the second artificial intelligence learning model may be performed based on the first data modification information for the determination result received through the first interface and the second data modification information for the image analysis result received through the second interface (S440).

Next, the first artificial intelligence learning model and the second artificial intelligence learning model may be updated through the retraining (S450).

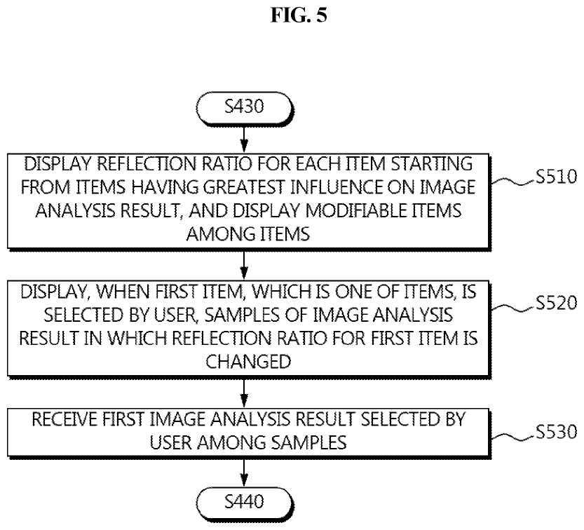

FIG. 5 is an operation flowchart showing a method for collecting data through HMI screen recognition and image analysis by using a camera according to one embodiment of the present invention.

Referring to FIG. 5, according to a method for collecting data through HMI screen recognition and image analysis by using a camera of one embodiment of the present invention, after the providing of the second interface, a reflection ratio for each item may be displayed starting from items having a greatest influence on the image analysis result, and modifiable items among the items may be displayed (S510).

Next, when a first item, which is one of the items, is selected by the user, samples of the image analysis result in which a reflection ratio for the first item is changed may be displayed (S520).

Next, a first image analysis result selected by the user among the samples may be received (S530).

In this case, in step S440, retraining of the second artificial intelligence learning model may be performed based on the first image analysis result.

Accordingly, when the artificial intelligence learning model is to be trained, the user may easily modify data by selecting one of the displayed samples without directly checking and modifying all data.

In some embodiments, retraining of the artificial intelligence learning model may be performed by using modification data obtained by directly modifying the data by the user.

In detail, the modification data obtained by directly modifying the data for the image analysis result may be received from the user through the second interface.

Next, the retraining of the second artificial intelligence learning model may be performed based on the received modification data.

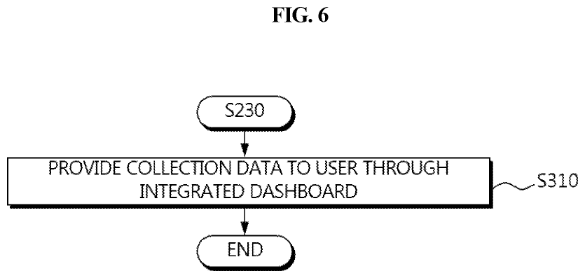

FIG. 6 is an operation flowchart showing a method for collecting data through HMI screen recognition and image analysis by using a camera according to one embodiment of the present invention.

Referring to FIG. 6, according to a method for collecting data through HMI screen recognition and image analysis by using a camera of one embodiment of the present invention, after the storing of the collection data, the collection data may be provided to the user through an integrated dashboard (S610).

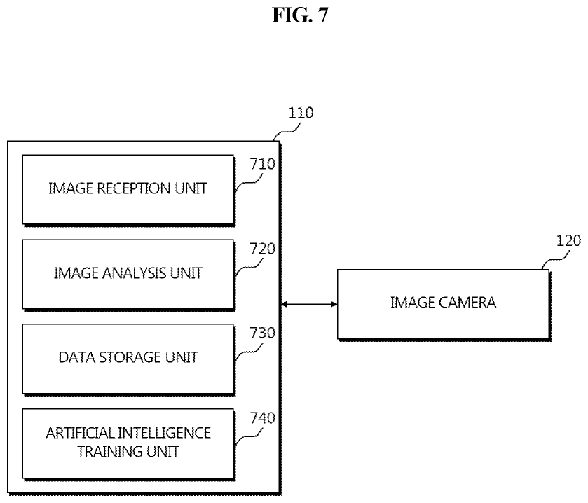

FIG. 7 is a view showing a configuration of an apparatus for collecting data through HMI screen recognition and image analysis by using a camera according to one embodiment of the present invention.

Referring to FIG. 7, according to one embodiment of the present invention, an apparatus for collecting data through HMI screen recognition and image analysis by using a camera may include: an image reception unit configured to receive an image from an image camera; an image analysis unit configured to generate an image analysis result by analyzing the image based on an artificial intelligence learning model; and a data storage unit configured to store collection data corresponding to the image.

According to one embodiment, the image reception unit may be configured to receive a first image obtained by capturing a screen of a human-machine interface (HMI) from the image camera, the image analysis unit may be configured to generate an image analysis result by analyzing the first image based on the artificial intelligence learning model configured to generate an analysis result by analyzing an image, and the data storage unit may be configured to store collection data corresponding to the first image based on the image analysis result.

According to one embodiment, the apparatus for collecting the data may further include an artificial intelligence training unit configured to train the artificial intelligence learning model, and the artificial intelligence training unit may be configured to train the artificial intelligence learning model by using the collection data.

In this case, the artificial intelligence learning model may include: a first artificial intelligence learning model configured to generate a determination result by determining information displayed on the HMI in the first image; and a second artificial intelligence learning model configured to generate the image analysis result for the first image based on the determination result and the information.

According to one embodiment, the artificial intelligence training unit may be configured to: provide a first interface, which is capable of receiving an input of data modification information for the determination result from a user, to a user terminal; generate the image analysis result for the first image based on the data modification information for the determination result received through the first interface; provide a second interface, which is capable of receiving an input of data modification information for the image analysis result from the user, to the user terminal; perform retraining of the first artificial intelligence learning model and the second artificial intelligence learning model based on the data modification information for the determination result received through the first interface and the data modification information for the image analysis result received through the second interface; and update the first artificial intelligence learning model and the second artificial intelligence learning model through the retraining.

According to one embodiment, the artificial intelligence training unit may be configured to: display, through the second interface, a reflection ratio for each item starting from items having a greatest influence on the image analysis result, and display modifiable items among the items; display, when a first item, which is one of the items, is selected by the user, samples of the image analysis result in which a reflection ratio for the first item is changed; receive a first image analysis result selected by the user among the samples; and perform retraining of the second artificial intelligence learning model based on the first image analysis result.

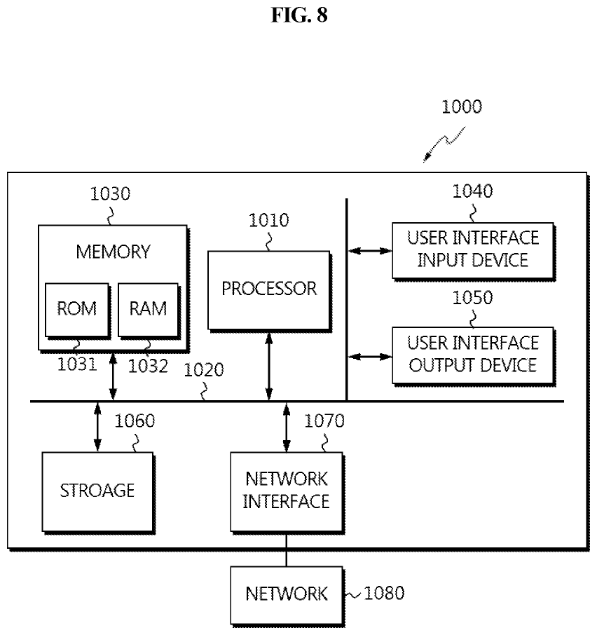

FIG. 8 is a view showing a computer system according to one embodiment of the present invention.

According to one embodiment of the present invention, an apparatus for collecting data through HMI screen recognition and image analysis by using a camera may be implemented in a computer system 1000 such as a computer-readable recording medium.

Referring to FIG. 8, the computer system 1000 may include at least one processor 1010, a memory 1030, a user interface input device 1040, a user interface output device 1050, and a storage 1060, which communicate with each other through a bus 1020. In addition, the computer system 1000 may further include a network interface 1070 connected to a network 1080. The processor 1010 may be a central processing unit or a semiconductor device for executing processing instructions stored in the memory 1030 or the storage 1060. The memory 1030 and the storage 1060 may be various types of volatile or nonvolatile storage media. For example, the memory may include a ROM 1031 or a RAM 1032.

The specific implementations described in the present disclosure are embodiments, and do not limit the scope of the present invention in any way. For brevity of the present disclosure, descriptions of conventional electronic configurations, control systems, software, and other functional aspects of the systems may be omitted. In addition, connections or connection members of lines between elements shown in the drawings illustratively represent functional connections and/or physical or circuit connections, and may be exhibited as various functional connections, physical connections, or circuit connections that are alternative or additional in an actual apparatus. In addition, when there is no specific description such as “essential”, “important”, or the like, the element may not be an essentially necessary element for application of the present invention.

Therefore, the idea of the present invention should not be limited to the embodiments described above, and the scope of the idea of the present invention may encompass the scope of the appended claims as well as all scopes equivalent to the claims or equivalently changed from the claims.

1. A method for collecting data through HMI screen recognition and image analysis by using a camera, the method comprising:
receiving a first image obtained by capturing a screen of a human-machine interface (HMI) from an image camera;
generating an image analysis result by analyzing the first image based on an artificial intelligence learning model configured to generate an analysis result by analyzing an image; and
storing collection data corresponding to the first image based on the image analysis result.

2. The method of claim 1, wherein, after the storing of the collection data, the method further comprises training the artificial intelligence learning model by using the collection data, and
the artificial intelligence learning model includes:
a first artificial intelligence learning model configured to generate a determination result by determining information displayed on the HMI in the first image; and
a second artificial intelligence learning model configured to generate the image analysis result for the first image based on the determination result and the information.

3. The method of claim 2, wherein the training of the artificial intelligence learning model includes:
providing a first interface, which is capable of receiving an input of first data modification information for the determination result from a user, to a user terminal;
generating the image analysis result for the first image based on the first data modification information for the determination result received through the first interface;
providing a second interface, which is capable of receiving an input of second data modification information for the image analysis result from the user, to the user terminal;
performing retraining of the first artificial intelligence learning model and the second artificial intelligence learning model based on the first data modification information for the determination result received through the first interface and the second data modification information for the image analysis result received through the second interface; and
updating the first artificial intelligence learning model and the second artificial intelligence learning model through the retraining.

4. The method of claim 3, wherein, after the providing of the second interface, the method further comprises:
displaying a reflection ratio for each item starting from items having a greatest influence on the image analysis result, and displaying modifiable items among the items;
displaying, when a first item, which is one of the items, is selected by the user, samples of the image analysis result in which a reflection ratio for the first item is changed; and
receiving a first image analysis result selected by the user among the samples, and
the performing of the retraining includes performing retraining of the second artificial intelligence learning model based on the first image analysis result.

5. The method of claim 4, wherein, after the storing of the collection data, the method further comprises providing the collection data to the user through an integrated dashboard.

6. An apparatus for collecting data through HMI screen recognition and image analysis by using a camera, the apparatus comprising:
an image reception unit configured to receive an image from an image camera;
an image analysis unit configured to generate an image analysis result by analyzing the image based on an artificial intelligence learning model; and
a data storage unit configured to store collection data corresponding to the image.

7. The apparatus of claim 6, wherein the image reception unit is configured to receive a first image obtained by capturing a screen of a human-machine interface (HMI) from the image camera,
the image analysis unit is configured to generate an image analysis result by analyzing the first image based on the artificial intelligence learning model configured to generate an analysis result by analyzing an image, and
the data storage unit is configured to store collection data corresponding to the first image based on the image analysis result.

8. The apparatus of claim 7, further comprising an artificial intelligence training unit configured to train the artificial intelligence learning model,
wherein the artificial intelligence training unit is configured to train the artificial intelligence learning model by using the collection data, and
the artificial intelligence learning model includes:
a first artificial intelligence learning model configured to generate a determination result by determining information displayed on the HMI in the first image; and
a second artificial intelligence learning model configured to generate the image analysis result for the first image based on the determination result and the information.

9. The apparatus of claim 8, wherein the artificial intelligence training unit is configured to:
provide a first interface, which is capable of receiving an input of data modification information for the determination result from a user, to a user terminal;
generate the image analysis result for the first image based on the data modification information for the determination result received through the first interface;
provide a second interface, which is capable of receiving an input of data modification information for the image analysis result from the user, to the user terminal;
perform retraining of the first artificial intelligence learning model and the second artificial intelligence learning model based on the data modification information for the determination result received through the first interface and the data modification information for the image analysis result received through the second interface; and
update the first artificial intelligence learning model and the second artificial intelligence learning model through the retraining.

10. The apparatus of claim 9, wherein the artificial intelligence training unit is configured to:
display, through the second interface, a reflection ratio for each item starting from items having a greatest influence on the image analysis result, and display modifiable items among the items;
display, when a first item, which is one of the items, is selected by the user, samples of the image analysis result in which a reflection ratio for the first item is changed;
receive a first image analysis result selected by the user among the samples; and
perform retraining of the second artificial intelligence learning model based on the first image analysis result.
